(19) United States
(12) Patent Application Publication
(10) Pub. No.: US 2012/0038706 A1
(43) Pub. Date: Feb. 16, 2012

(54) Line Head Wiping Method

(75) Inventors: Hideo IZAWA, Narashino-shi (JP); Akira Ishikawa, Narashino-shi (JP); Wataru Itabashi, Narashino-shi (JP)

(73) Assignee: Miyakoshi Printing Machinery Co., Ltd., Narashino-shi (JP)

(21) Appl. No.: 13/207,158

(22) Filed: Aug. 10, 2011

(30) Foreign Application Priority Data
Aug. 10, 2010 (JP) JP 179462/2010

(51) Int. Cl. B41J 2/165

(52) U.S. Cl. 347/33

(57) ABSTRACT

A method of wiping a line blade with a blade is disclosed that prevents premature wear and break of the blade and preserving its elastic deformation from soiling the environment. Accordingly, in the method of wiping the line head 3 comprising a plurality of nozzle heads 3a, 3b, 3c, 3d each of which has a head bottom face and a nozzle face A in which a number of open ink nozzles are formed, the nozzle face lying centrally of the head bottom face in a direction of printing width and being flush with the head bottom face, the nozzle heads being arranged in a direction of printing width and supported by a carriage 4 wherein the head bottom face of each of the nozzle heads of the line head is wiped with a blade 11 moved relative thereto in a direction of printing width, wiping is effected with an end of the blade 11 brought into contact with the head bottom face from a position between one end of the head bottom face in the direction of printing width and the corresponding one end of the nozzle face to a position between the other end of said head bottom face in the direction of printing width and the corresponding other end of the nozzle face.

### RELATED APPLICATIONS

This application claims priority of Japanese application no. 2010-179462 filed Aug. 10, 2010, the entire content of which is hereby incorporated by reference.

### FIELD OF THE INVENTION

The present invention relates to a line head wiping method for wiping nozzle faces of a line head that constitutes a printing head in an ink jet recording apparatus.

### BACKGROUND OF THE INVENTION

A wiping method of this sort has been known as shown in FIG. 1 for a plurality of nozzle heads a, b, c and d having nozzle faces at their end portions that protrude from a lower surface of a carriage e. When the carriage e is moved from a printing region over to a wiping region along a guide rail f, a blade g under the carriage e is moved up to a position at which its end portion can interfere with the protruding end portions of the nozzle heads a to d. As the carriage e is moved, nozzle faces that are constituted by the end faces of the protruding end portions of the nozzle heads a to d are rubbed and wiped by the blade g along the lower surface of the carriage e (see JP H04-371851 A).

In the abovementioned wiping method in the prior art, the end portion of the wiping blade g before the nozzle heads moving with the carriage e arrive reaches the position where it comes into flexural contact with a portion of the lower surface of the carriage e on the near side of the nozzle head a most downstream in the direction of movement of the carriage. Thereafter, the end portion of the blade g comes to interfere with the end portions of the nozzle heads a to d successively to wipe them.

Thus, since the end portion of the wiping blade g while being elastically deformed against and getting over the end portion of each nozzle head a, b, c, d is to wipe the nozzle face, a large shear force acts on the end portion of the blade g while getting over the end portion of the nozzle head a, b, c, d, giving rise to the problem that a premature wear or break tends to occur there.

Also, foreign matter that may have been attached to the end portion of the blade g when starting to wipe tends to be attached to a corner of the end portion of the most downstream nozzle head a. And, in ending the wiping, when the end portion of the blade g comes off the end portion of the nozzle head d most upstream in the direction of movement of the carriage, instantaneous release of the end portion of the blade g from its elastic deformation may cause the foreign matter attached to the blade g to be scattered into its surroundings, presenting the problem that an ambient component and the recording medium may be soiled thereby.

The printing head may include a line head that has a plurality of nozzle heads which are arranged in a direction of printing width and carried by a carriage and each of which is formed at its end with a head bottom face including a nozzle face and flush with a lower surface of the carriage. The line head in this case is wiped over a full length in a direction of printing width by a blade that is wider in width than the head bottom face in the state that its end is brought into flexural contact with the lower surface of the carriage.

Attaching such nozzle heads to the carriage so that each head bottom face is flush with the lower surface of the carriage allows a groove to become created between the periphery of the head bottom face and its surrounding surface of the carriage where the end corner of the nozzle head is usually chamfered.

Thus, wiping then over the entire lower surface of the carriage allows ink as attached to the blade end while wiping the head bottom face to become entering the groove, with the result that the lower surface of the line head may not be wiped neatly.

Also if such nozzle heads are attached to the carriage so that each head bottom face is flush with the lower surface of the carriage, each head bottom face may be recessed slightly from the lower surface of the carriage due to a dimensional error or the like. Then, wiping with the blade end in flexural contact with the lower surface of the carriage may leave ink around a region of the head bottom face. Here again, the lower surface of the line head cannot be wiped neatly.

### SUMMARY OF THE INVENTION

One object of the present invention is to provide a method of wiping a line head having a plurality of nozzle heads arranged in a direction of printing width and carried by a carriage wherein a head bottom face of each of the nozzle heads is wiped with a blade, the method preventing premature wear and break of the blade and preventing soiling of the environment by its elastic deformation even where a line head having the head bottom face of a nozzle head protruding from a lower surface of the carriage is wiped, the method making it possible to wipe a lower surface of a line head neatly for in which the head bottom face of a nozzle head is made flush with the lower surface of the carriage or in which the head bottom face is slightly recessed from the lower surface of the carriage, and the method furthermore ensuring an elongated useful life of the blade by wiping the minimum requisite area of the line head.

In order to achieve the object mentioned above there is provided in accordance with one aspect of the present invention a method of wiping a line head comprising a plurality of nozzle heads each of which has a head bottom face and a nozzle face in which a number of open ink nozzles are formed, the nozzle face lying centrally of the head bottom face in a direction of printing width and being flush with the head bottom face, the nozzle heads being arranged in a direction of printing width and supported by a carriage wherein the head bottom face of each of the nozzle heads of the line head is wiped with a blade moved relative thereto in a direction of printing width, characterized in that wiping is effected with an end of the said blade brought into contact with the said head bottom face from a position between one end of the said head bottom face in the direction of printing width and the corresponding one end of the said nozzle face to a position between the other end of the said head bottom face in the direction of printing width and the corresponding other end of the said nozzle face.

Further, in the line head wiping method mentioned above, the plurality of nozzle heads of the line head may be arranged zigzag (staggered) so that their nozzle faces are linked together in a direction of printing width, the head bottom faces of the plurality of nozzle heads being wiped successively in the direction of printing width. Also, the plurality of nozzle heads of the line head are each preferably in the form of a rectangle (reed-shape) and may be arranged in a direction of printing width with an inclination, the head bottom faces of the plurality of nozzle heads being wiped as a whole in the direction of printing width.

And, in the line head wiping method mentioned above, wiping with said blade may be effected over a width in a direction orthogonal to the direction of printing width of the nozzle head, the width being narrower than the corresponding one of the head bottom face and wider than the corresponding one of the nozzle face.

Further, the blade may be adapted to be inclined fore and aft with an angle of inclination of −30 to +30 degrees to a direction orthogonal to the direction of printing width.

According to an embodiment of the method of the present invention, it can be seen that if it is applied to a line head in which the head bottom face of the end portion of each of a plurality of nozzle heads protrudes from a lower surface of the carriage, the blade for wiping the head bottom face is allowed to wipe only the head bottom face (planar section) of the nozzle head. Thus, the blade is freed from contacting a corner of the end portion of the nozzle head, making it possible to prevent its premature wear and break.

Also, according to an embodiment of the present method, freeing the blade from flexurally contacting a corner of the end portion of the nozzle head protruding from the lower surface of the carriage keeps foreign matter that may have be attached to the end of the blade from attaching to such a corner of the end portion of the nozzle head. Also, when the wiping is ended at which time the blade end portion is released from its sliding (elastic deformation) on the head bottom face, there is no foreign matter scattered by rebounding from the elastic deformation due to the flexural contact. This prevents the wiping action from soiling the environment.

Further, according to an embodiment of the present invention, since wiping with the blade is effected over a width in a direction orthogonal to the direction of printing width of the nozzle head, the width being narrower than the corresponding one of the head bottom face and wider than the corresponding one of the nozzle face, wiping with the blade can be effected over on an area slightly larger than the nozzle face of each nozzle head and thus with a minimized wiping area, making it possible to ensure an elongated useful life of the blade. And, even if the head bottom face of each nozzle head is made flush with or recessed slightly from the lower surface of the carriage, there is no ink that can be left in a groove as formed on a lower surface of the line head or in a corner of the recess, making it possible to wipe the lower surface of the line head in that state.

Also, with a blade inclined in a range of −30 to +30 degrees to a direction orthogonal to the direction of printing width, the wiping action for the lower surface of a line head is bettered.

### BRIEF DESCRIPTION OF THE DRAWINGS

FIG. 1 is an explanatory view illustrating a method in the prior art;

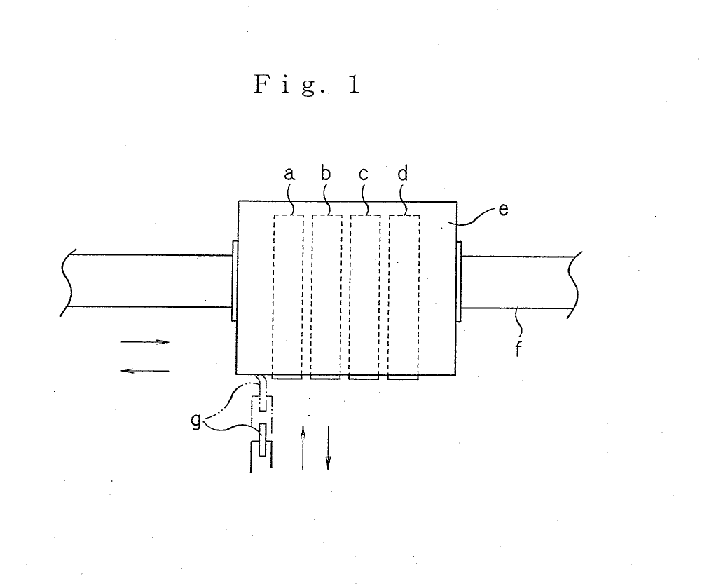

FIG. 2 is an explanatory view illustrating an essential part of an ink jet recording apparatus for carrying out a method according to an embodiment of the present invention;

FIGS. 3A and 3B are a front and a bottom view, respectively, of an essential part of a line head which are used as explanatory views to illustrate a wiping operation on the line head;

FIGS. 4A and 4B are each a cross sectional view illustrating the makeup and operation of a wiping unit provided with a cleaning function; and

FIGS. 5A and 5B are a front and a bottom view, respectively, of an essential part of an alternative form of the line head which are used as explanatory views to illustrate a wiping operation thereon.

### DETAILED DESCRIPTION OF THE DRAWINGS

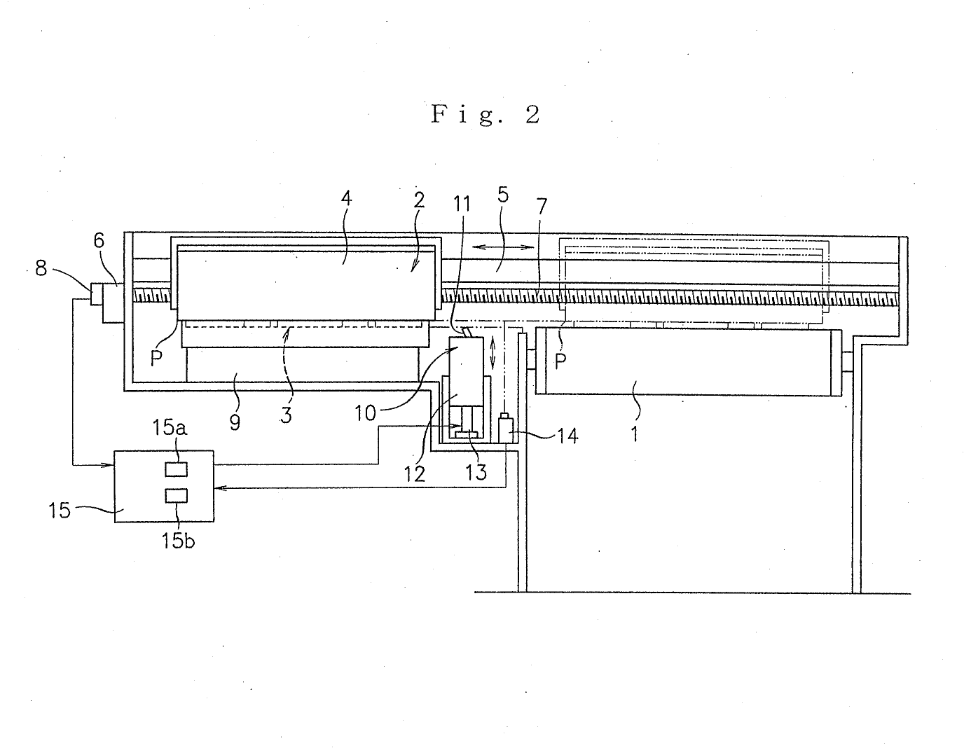

FIG. 2 is an explanatory view that diagrammatically shows an ink jet recording apparatus for carrying out the present invention. The apparatus includes a conveyor (platen) 1 by which a recording medium (continuous sheet of recording paper) can be conveyed to pass orthogonally to the sheet of drawing and a printing head 2 positioned at an upper side of the conveyor 1 for printing over an entire width of the recording medium conveyed by the conveyor 1. At a lower surface of the printing head 2 there is a line head 3 supported by a carriage 4 so as to be opposite to the continuous sheet of paper entirely its widthwise.

The printing head 2 can be guided by a guide rail 5 between a printing region above the conveyor 1 for printing with the line head 3 on the recording medium over a given width and a maintenance region established shifted from the printing region in a direction of printing width. The printing head 2 can be moved by a feed screw 7 driven to rotate by a motor 6. A movement of the printing head 2 is proportional to a number of revolutions of the feed screw 7 which is proportional to a number of revolutions of the motor 6. The movement of the printing head 2 can thus be detected by an encoder 8 for detecting the number of revolutions of the motor 6.

In the maintenance region, there is arranged a purging unit 9 for purging the line head 3 of the printing head 2. The purging unit 9 is movable vertically. In a purging operation, it is moved up so that its upper end is made in contact with a lower surface of the carriage 4 for the printing head 2. Note further that the purging unit 9 is here of suction type to recover the line head 3 and if there is arranged a recovery means of pressure type to recover the line head 3, the purging unit 9 is used as a cap receiving ink blown off from the line head 3.

Between the printing and maintenance regions, there is arranged a wiping unit 10 that can be made in rubbing contact with a lower surface of the line head 3 for the printing head 2 moving from the printing region to the maintenance region. The wiping unit 10 is constituted of a blade 11 that can be brought into contact with the head bottom face, a blade support cylinder 12 for supporting the blade 11 and a lifting means 13 for moving the cylinder 12 together with the blade 11 up and down to bring an end of the blade 11 into and out of contact with the lower surface of the line head 3.

Between the printing and maintenance regions, there is also arranged a printing head detector 14 between the wiping unit 10 and the printing region for detecting a point P of the printing head 2 moving from the printing region to the maintenance region, e.g., as an end point of the carriage 4 on the side of the maintenance region.

A controller 15 is provided to receive detected values respectively by the encoder 8 and the printing head detector 14. In response to these detected values, the controller 15 can furnish a signal to operate the lifting means 13 of the wiping unit 10 in automatic sequences. In this form of implementation of the invention, the operation is such that when the point P of the carriage 4 detected by the printing head detector 14 for the printing head 2 moving towards the maintenance region has then moved a given distance, the lifting means 13 of the wiping unit 10 is operated to move the blade 11 up and down as in steps to be described.

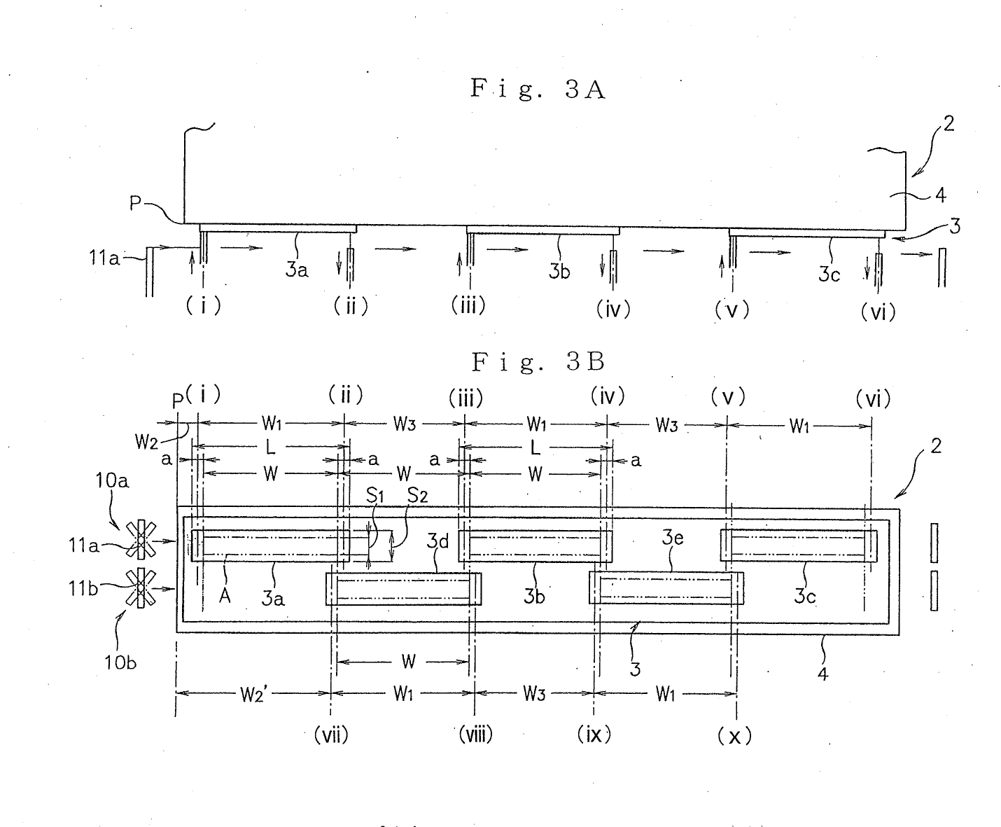

FIGS. 3A and 3B shows an embodiment of the line head 3. In this form of implementation, five (5) nozzle heads 3a, 3b, 3c, 3d and 3e are configured and arranged zigzag (staggered) in two lines. With this line head, the continuous sheet of paper can be printed on with a single color over an entire width thereof except for a given area at each of its both sides.

The nozzle heads 3a-3e as shown in FIG. 3A have their end head bottom faces evenly protruded slightly from the carriage 4. Each nozzle head 3a-3e as shown in FIG. 3B has, centrally of its bottom face, a nozzle face A of a given area which is flush with the head bottom face and in which a given number of ink nozzles are formed, wherein the width of the nozzle face A in the direction of printing width constitutes an effective printing width W of each nozzle head. An end of the nozzle face A in the direction of printing width lies inside by a given dimension a from an end of the head bottom face in the direction of printing width, and the effective printing width W is of (L-2a) with respect to the total width L of the head bottom face in the direction of printing width. In this connection, the width of the nozzle face A and the width of the head bottom face in the direction orthogonal to the direction of printing width are assumed to be S1 and S2, respectively.

Of the five (5) nozzle heads 3a-3e in two lines that make up the line head 3, the three (3) nozzle heads 3a, 3b and 3c in the first line as shown in FIG. 3 are arranged in a direction of printing width so that the spacing between the adjacent nozzle faces A becomes the effective printing width W. And, the two (2) nozzle heads 3d and 3e in the second line are arranged so that their effective printing width W is coincident with the effective printing width W between the adjacent nozzle heads in the first line. In this line head 3 in which the effective printing widths W of the five nozzles heads 3a-3e are continuously linked together in a direction of printing width, it follows, therefore, that printing with a printing width that is five times of the effective printing width W is effected on the recording medium.

The head bottom face of each of the nozzle heads 3a to 3e of the line head 3 so configured as mentioned above is wiped while the printing head 2 is being moved from the printing region to the maintenance region and when the end of the blade 11 at the upper position in the wiping unit 10 is brought into rubbing contact with the head bottom face. In this form of implementation, two wiping units 10A and 10B as shown in FIG. 3B are provided so as to confront two lines, respectively, of the line head 3 into which a plurality of nozzle heads 3a to 3e are grouped in the printing direction. In these wiping units 10A and 10B, blades 11a and 11B are made individually movable up and movable down in accordance with timings of movement to the maintenance region of the nozzle head 3a, 3b and 3c in the first line and the nozzle heads 3d and 3e in the second line.

In the first line in which three nozzle heads 3a, 3b and 3c are arranged, each of positions of blade contact (i), (ii), (iii), (iv), (v), (vi) is established corresponding to one half of each of distances a between both ends of each nozzle head 3a, 3b, 3c in the direction of printing width and both ends of each nozzle face A therein in the direction of printing width. Then, each width or spacing W1 between these positions of blade contact (i)-(ii), (iii)-(iv), (v)-(vi) with the nozzle heads 3a, 3b, 3c becomes (W+a). Also, each width r spacing W3 between the positions of blade contact (ii)-(iii), (vi)-(v) with the nozzle heads 3a, 3b, 3c becomes (W-a). And, a width or distance between the position of blade contact (i) at which the nozzle head 3a begins to be contacted by the blade 11a in the maintenance region and point P at the end of the carriage 4 on the side of the maintenance region is established as W2.

In the second line in which two nozzle heads 3d and 3e are arranged, each position of blade contact (vii), (viii), (ix), (x) with each nozzle head 3d, 3e is established as in the first line. And, a width or distance between the position of blade contact (vii) with the nozzle head 3d and the point P mentioned above is established as W2′.

The controller 15 is provided with a first and a second control unit 15a and 15b for operating the blades 11a and 11b in the wiping units 10a and 10b for the first and second lines of the line head 3, respectively, which are shown in FIGS. 3A and 3B. Mention is made below of an operation of the wiping units 10a and 10b by these control units.

With the wiping units 10a and 10b deactivated, the ends of the blades 11a and 11b are positioned on standby below a level of the head bottom faces of the nozzle heads 3a-3e of the line head in the printing head 2. Now in movement of the printing head 2 towards the maintenance region, when the point P of the carriage 4 is detected by the printing head detector 14, the printing head 2 is moved from this position P by W2 to a position (i), at which it is brought to a halt and stands still for a time. While the printing head 2 stands still, the blade 11a in the wiping unit 10a for the first line is moved up, reaching the position of blade contact (i) with the first nozzle head 3a. At this position, the end of the blade 11a which is made in contact with the bottom face of the nozzle head 3a may be somewhat deformed to come into flexural contact therewith.

In this state, by moving the printing head 2 towards the maintenance region, the lower surface (namely, head bottom face) of the nozzle head 3a is wiped by the blade 11b. And, the printing head 2 is moved by a distance W1 to a position (ii) at which it is temporarily stopped. This position of blade contact (ii) with the first nozzle head 3a has then been reached by the blade 11a. The blade 11a is then moved by the wiping unit 10a down to stay on standby, separated from the head bottom face of the nozzle head 2. Thence, the printing head 2 is moved by a distance W3.

The wiping unit 10a is maintained on standby while the printing head 2 is moved by the distance W3. Thereafter, when the printing head 2 has been moved by the distance W3 and is temporarily stopped, the blade 11a is again moved up, reaching a position (iii). The end of the blade 11a in the wiping unit 10a is thus brought into contact with the second nozzle head 3b at the position of blade contact (iii). The subsequent movement of the second printing head 2 by the distance W1 allows the lower surface of the second nozzle head 3b to be wiped by the blade 11a over the width W1. And, when the blade 11a reaches a position of blade contact (iv) and the printing head 2 is temporarily halted, the blade 11a is moved down by the wiping unit 10a to stay on standby, separated from the lower surface of the nozzle head 3b.

The abovementioned cycle of operation is effected as well for the blade 11a to be positioned relatively to confront the third nozzle head 3c wherein at the position of blade contact (v) with the third nozzle head 3c the blade 11a is moved up to start wiping the lower surface of the nozzle head 3c and at the position of blade contact (vi) the blade 11a is moved down by the wiping unit 10a for standby.

In the mean time, the wiping unit 10b for the second line is operated interlocked with operation of the wiping unit 10a for the first line. Starting from the state that the printing head 2 has been moved by a distance W2′ after detection of the point P, the wiping unit 10b for the second line is operated as the wiping unit 10a for the first line

In wiping operation, there is an overlap between the first and second lines. During wiping of a nozzle head on the first line, there is a temporary stop of movement of the printing head 2 by wiping operation for a nozzle head in the second line. Also, during wiping of a nozzle head on the second nozzle head in the second line, there is a temporary stop of movement of the printing head 2 by wiping operation for a nozzle head in the first line. With the printing head 2 temporarily stopped to move in wiping each of all the nozzle heads 3a to 3d, the nozzle faces of the nozzle heads 3a to 3e are wiped over defined extents of (i)-(ii) (iii)-(iv), (v)-(vi), (vii)-(viii) and (ix)-(x), respectively.

For each of the line for the nozzle heads 3a to 3c and the line for the nozzle heads 3d and 3e, it should be noted here that the printing head 2 may be reciprocated twice, and wiping operation for the second line may be performed after the wiping operation for the first line is terminated. In this case, there is no temporary stop of wiping by a blade due to temporary stop of movement of the printing head 2 in wiping each nozzle head, and wiping of an entire wiping length for each nozzle head is done in a single action.

By the wiping operation mentioned above, the head bottom surface of each of the nozzle heads 3a to 3e is wiped over a blade contact point spacing W1. The head bottom face of an effective printing width W of the nozzle face A inside of the blade contact point spacing W1 is wiped.

In this way, the blade 11a, 11b in the wiping unit 10a, 10b is brought into contact with the head bottom face in a spacing from one end, on the side of the maintenance region, of each nozzle head 3a, 3b, 3c, 3d, 3e to one end of the nozzle face A to initiate acting to wipe the nozzle face A. After acting to wipe the nozzle face A, the blade 11a, 11b in the wiping unit 10a, 10b continuing to wipe and having acted to wipe a planar portion of the head bottom face of each nozzle head 3a, 3b, 3c, 3d, 3e is separated from the head bottom face in a spacing from the other end of the nozzle face A to the other end of the nozzle head on the side of the printing region.

While the blade 11a, 11b in the wiping unit 10a, 10b is wiping a nozzle head in each line, a problem arises that ink as adhered on the nozzle face may be transferred onto the blade. In continuing to wipe with the blade, it is feared that ink as transferred to the blade may be transferred to a next nozzle head.

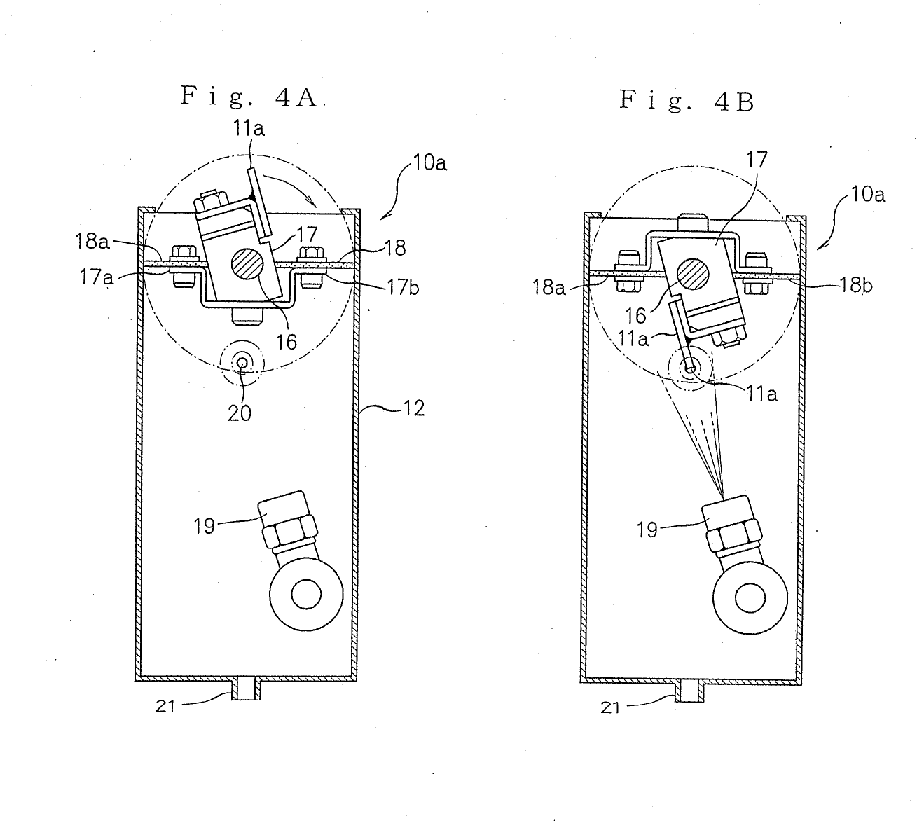

In order to resolve the problem, there has been proposed an arrangement in which in an interval between successive cycles of wiping as mentioned above, each time a blade finishes wiping a nozzle head or wiping a plurality of nozzle heads in each line, the blade is cleaned (see JP 2008-119,836 A). FIGS. 4A and 4B are each a cross sectional view that illustrates the makeup and operation of a wiping unit equipped with a self-cleaning function.

Mention is made of a first wiping unit 1 for wiping nozzle heads 3a to 3b in a first line. In the description of this form of implementation, the lifting means for moving up and down the blade support cylinder 12 is omitted from illustration.

The blade support cylinder 12 is here in the form of a bottomed rectangular cylinder, in whose upper part a rotating shaft 16 is journaled extending in a direction orthogonal to that in which the printing head 2 is moved. The rotating shaft 16 has a blade supporting member 17 fastened thereto, to which the blade 11a is in turn fastened with an inclination so that its upper part is oriented towards the maintenance region in the direction in which the printing head 2 is moved. The blade 11a is composed of hard rubber or any other suitable material that is suitable in its elasticity.

The blade supporting member 17 is of a length such that its both ends are in contact with inner surface of the blade support cylinder 12. The blade supporting member 17 also has, at both sides of its axis of rotation, supporting pieces 17a and 17b fastened thereto as shown in FIG. 4A. The supporting pieces 17a and 17b in turn have rectangular leakproof plates 18a and 18b fastened thereto, respectively.

When the rotating shaft 16 is rotated, the blade supporting member 17 is designed to rotate by about 180 degrees between a wiping state in which the blade 11a is oriented upwards as shown in FIG. 4A. 4A and a storing state in which the blade 11a is oriented downwards as shown in FIG. 4B. The leakproof plate 18a and 18b are made horizontal at least when the blade supporting member 17 is in the storing state so that their ends and both side ends may be closely in contact with the inner surface of the blade support cylinder 12. It should be noted further that the leakproof plate 18a and 18b may be composed of an elastic material such as rubber plate so that their ends and both side ends can be closely in elastic contact with the inner surface of the blade support cylinder 12.

In the lower part of the blade support cylinder 12, there is provided a cleaning liquid spray nozzle 19 oriented towards the blade 11a in the storing state. Also, the blade support cylinder 12 has an air nozzle 20 formed in its side wall such that it laterally confronts the end portion of the blade 11a in a storing position such as mentioned above. The blade support cylinder has a drain hole 21a formed in its bottom plate.

In wiping operation by the wiping unit 10a, the rotary shaft 16 is driven by a rotary actuator (not shown) to bring the blade 11a into the wiping state in which it is oriented upwards and the lifting means 13 is driven to move the blade support cylinder 12 up to a position at which it is restrained by a stopper (not shown).

By moving the printing head 2 towards the maintenance region in this state, the head bottom face of the nozzle head of the printing head 2 is wiped with the blade 11a, thereby ink adhered to the nozzle face is wiped and scraped off. Ink scraped off is adhered to the blade 11a which after wiping operation is cleaned in a cleaning operation.

The cleaning operation for the blade 11a is carried out as mentioned below.

The rotary actuator is driven to bring the blade 11a into the storing state in which it is oriented downwards as shown in FIG. 4B. In this state, the leakproof plate 18a and 18b are oriented horizontally to bring and hold their ends and side ends in elastic contact with the inner surface of the blade support cylinder 12. A space of the upper part within the blade support cylinder 12 is closed liquid-tight with these leakproof plates 18a and 18b and both sides of the blade supporting member 17.

In this state, a cleaning liquid is sprayed from the cleaning liquid spray nozzle 19. The cleaning liquid is then sprayed from the cleaning liquid spray nozzle 19 directly towards the blade 11a to flush ink adhered on the blade 11a. Here, the cleaning liquid is kept from leaking into above the blade support cylinder 12 and drained through the drain hole 21. After spraying the blade 11a with the cleaning liquid, the air nozzle 20 sprays the blade 11a with air to dry the blade 11a.

The cleaning operation mentioned above is effected in the state that the blade support cylinder 12 in the wiping means 10 is moved down, each time each of the nozzles 3a, 3b and 3c arranged in a line has been wiped.

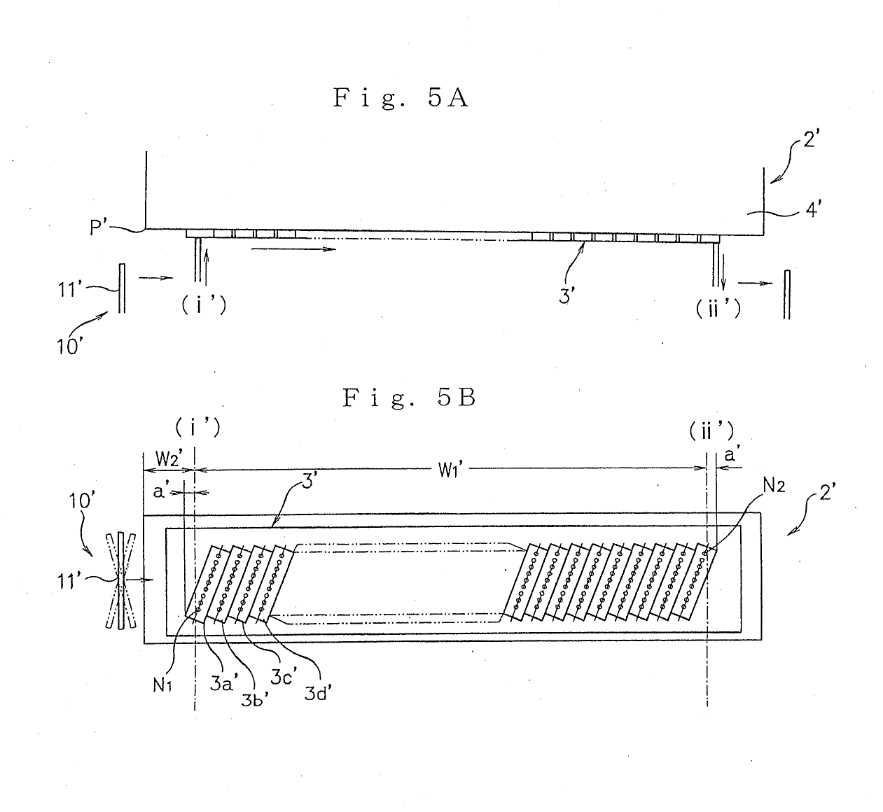

FIGS. 5A and 5B shows another embodiment of the printing head to be wiped. In this alternative embodiment, the printing head 2′ has a line head 3′ comprising a plurality of rectangular (reed-shaped) nozzle heads 3a′, 3b′, 3c′, . . . arranged in a direction of printing width with an angle of inclination thereto. In this line head 3′, the lower surface of all the nozzle heads 3a′, 3b′, 3c′, . . . as a whole corresponds to a head bottom face of a nozzle head 3a, 3b, 3c, 3d, 3e, and the lower surface of all portions as a whole of the nozzle heads 3a′, 3b′, 3c′, . . . in which ink nozzles are open corresponds to a nozzle face of the nozzle head, 3a, 3b, 3c, 3d, 3e, in the embodiment shown in FIGS. 3A and 3B. And, an effective printing width W1′ in this embodiment is equal to a dimension between, outmost nozzles N1 and N2 of the nozzle heads positioned at both ends of the line head.

On the other hand, a blade 11′ in a wiping unit 10′ for wiping the nozzle face of the line head 3′ is made somewhat longer than a width of the line head 3′ in the printing direction (the direction in which the recording medium is moved). And, when printing head 2′ is moved towards the maintenance region and its point P′ is detected by the printing head detector 14 whereby the line head 3′ is moved by a distance W2 to a position (i′) at which the printing 2′ head is temporarily stopped, the blade 11′ is moved up in the wiping unit 10′ to bring its end into contact with the head face (head bottom face) of the nozzle head 3a′ slightly outside of the nozzle at an end of the line head on the side of the maintenance region. A subsequent movement of the printing head 2′ towards the maintenance region causes wiping the head bottom face of the line head 3′. And, at the position (ii′) to which the printing head 2′ is moved by the distance W1, the blade 11′ lies outside of the nozzle of the nozzle head at an end of the line head on the side of the printing region. When the printing head 2′ is temporarily halted there, the blade 11′ in the wiping unit 10′ is moved down, leaving the head face of the nozzle head at the end of the line head on the side of the printing region without passing beyond the end of the head face of that nozzle head.

In this alternative embodiment of printing head, the end of the blade 11′ comes in contact with the head bottom face at the position (i) which is entered by a distance a′ into the upstream side from the downstream end of the head bottom face of the most downstream side nozzle head 3a′ in the direction of movement of the printing head 2′ and which is near side of the nozzle face of the nozzle head 3a′, the blade 11′ starting to wipe at this position and acting to wipe over the effective printing width W1 of the line head 3′. The blade 11′ comes out of contact with the head bottom face at a position (ii′) which is past the nozzle face of the most upstream side nozzle head and which is downstream by the distance a′ from the most upstream end of the head bottom face of the nozzle head.

In each of the forms of implementation mentioned above, 11a, 11b, 11′ in the wiping unit 10a, 10b, 10′ may not necessarily be oriented orthogonally to the direction of movement of the printing head 2, 2′ as shown in FIG. 3B and FIG. 5B but may possibly be inclined fore and aft to a direction orthogonal to the direction of movement of the printing head 2, 2′, as shown by at an angle in the range of ±30°, for example an angle of +15 or −15 degrees, thereby bettering the wiping action.

While in the embodiments of the wiping unit, a wiping operation is illustrated as effected such that a printing head is moved for each line or while intermittently halting and in conjunction therewith a wiping blade in the wiping unit is moved up and down, it should be noted that with respect to a lower surface of the printing head moved to a maintenance position the wiping unit may be moved over an entire length of the printing head in a direction of printing width while moving the blade up and down in accordance with a layout of head bottom faces of nozzle heads of the printing head.

Also, while in the embodiments mentioned above, the end portion of each nozzle head of the line head is illustrated as protruding from the lower surface of a carriage, note that the end portion (head bottom face) of the nozzle head may be made flush with the lower surface of the carriage to achieve a like function.

In this case, the wiping width of the blade 11 in the wiping unit 10 should preferably be made narrower than a width S2 orthogonal to the direction of printing width and wider than a width S1 of the nozzle face A as shown in FIG. 3B.

By making so, it is possible to wipe each nozzle head over a minimum area. In this case, it is possible to wipe the nozzle head 3a, 3b, 3c, 3d, 3e without hindrance if its head bottom face is recessed from the lower surface of the carriage 4.

We claim:

1. A method of wiping a line head comprising a plurality of nozzle heads each of which has a head bottom face and a nozzle face in which a number of open ink nozzles are formed, the nozzle face lying centrally of the head bottom face in a direction of printing width and being flush with the head bottom face, the nozzle heads being arranged in a direction of printing width and supported by a carriage wherein the head bottom face of each of the nozzle heads of the line head is wiped with a blade moved relative thereto in a direction of printing width,
wherein wiping is effected with an end of said blade brought into contact with said head bottom face from a position between one end of said head bottom face in the direction of printing width and the corresponding one end of said nozzle face to a position between the other end of said head bottom face in the direction of printing width and the corresponding other end of said nozzle face.

2. The method of wiping a line head as set forth in claim 1, wherein said plurality of nozzle heads of said line head are arranged zigzag so that their nozzle faces are linked together in a direction of printing width, characterized in that said head bottom faces of said plurality of nozzle heads are wiped successively in the direction of printing width.

3. The method of wiping a line head as set forth in claim 1, wherein said plurality of nozzle heads of said line head are each in the form of a rectangle and arranged in a direction of printing width with an inclination, characterized in that said head bottom faces of said plurality of nozzle heads are wiped as a whole in the direction of printing width.

4. The method of wiping a line head as set forth in claim 1, wherein wiping with said blade is effected over a width in a direction orthogonal to the direction of printing width of the nozzle head, the width being narrower than the corresponding one of said head bottom face and wider than the corresponding one of said nozzle face.

5. The method of wiping a line head as set forth in claim 1, wherein said blade is adapted to be inclined fore and aft with an angle of inclination of −30 to +30 degrees to a direction orthogonal to the direction of printing width.
